(19) United States
(12) Patent Application Publication
(10) Pub. No.: US 2024/0384871 A1
(43) Pub. Date: Nov. 21, 2024

(54) CHIMNEY SENSING AND FIRE SAFETY

(71) Applicant: STATE FARM MUTUAL AUTOMOBILE INSURANCE COMPANY, Bloomington, IL (US)

(72) Inventor: Brian N. Harvey, Bloomington, IL (US)

(21) Appl. No.: 18/202,345

(22) Filed: May 26, 2023

Related U.S. Application Data
(60) Provisional application No. 63/467,418, filed on May 18, 2023.

(51) Int. Cl. F23N 5/14; G01J 5/07; G01K 1/143; G01K 3/00; G06N 5/022

(52) U.S. Cl. CPC F23N 5/143; G01J 5/07; G01K 1/143; G01K 3/005; G06N 5/022

(57) ABSTRACT

The following relates generally to improving chimney safety through monitoring and detection of overheat conditions or animal intrusion that may damage a chimney or result in uncontrolled fire spreading outside the chimney. To improve chimney safety, a system may use temperature levels, sound signals, and/or imagery data to determine an overheat condition in a chimney. Upon determination of an overheat condition, the system may send an alert to a mobile device of a user or take other action (e.g., shutting off gas to a firebox, alerting the fire department, etc.). Similarly, sound signals and/or imagery data may be used to determine the presence of: (i) animals within or near the chimney, and/or (ii) water in the chimney box (e.g., water on a wall of the chimney box, or dripping to the bottom of the chimney box).

### CROSS-REFERENCE TO RELATED APPLICATIONS

This application claims priority to U.S. Patent Application No. 63/467,418, entitled “Chimney Sensing and Fire Safety,” filed May 18, 2023, the entirety of which is incorporated by reference herein.

### FIELD

The present disclosure generally relates to chimney safety and particularly to systems and methods of monitoring chimney conditions to improve safety.

### BACKGROUND

Chimneys may have associated dangers and/or hazards. For example, an overheated chimney may become damaged. In this regard, chimneys are particularly vulnerable at connection sections of the chimney (e.g., connection sections joining two separate chimney sections). In addition, small animals may enter a chimney and/or bring objects into a chimney (e.g., to build a nest with, etc.).

The systems and methods disclosed herein provide solutions to these problems and may provide solutions to the ineffectiveness, insecurities, difficulties, inefficiencies, encumbrances, and/or other drawbacks of conventional techniques.

### SUMMARY

The present embodiments relate to, inter alia, improving chimney safety. For example, chimneys may become damaged when overheated. To reduce this risk, the systems and methods discussed herein may determine an overheat condition in a chimney and, in response, alert a homeowner and/or take other appropriate action. In addition, small animals may enter a chimney, and the techniques described herein may take appropriate action for this problem as well (e.g., alert the home owner, activate a device to repel the animal, prevent a fire from starting while the animal is in the chimney, etc.).

In one aspect, a chimney safety system may be provided. The chimney safety system may include one or more local or remote processors, sensors, transceivers, servers, memory units, and/or other electronic or electrical components. For example, in one instance, the chimney safety system may include at least one temperature sensor configured to measure temperature associated with a portion of a chimney. The chimney safety system may further include one or more processors configured to: (1) determine a temperature based upon a temperature signal received from the at least one temperature sensor; and/or (2) determine that a chimney overheat condition exists based upon the determined temperature. The computer system may include additional, less, or alternate functionality, including that discussed elsewhere herein.

In another aspect, a computer-implemented method for chimney safety may be provided. The method may be implemented via one or more local or remote processors, sensors, transceivers, servers, memory units, and/or other electronic or electrical components. For instance, in one example, the method may include: (1) receiving, via one or more processors, a temperature signal from a temperature sensor configured to measure a temperature associated with a portion of a chimney; (2) determining, via the one or more processors, a temperature level from the temperature sensor; and/or (3) determining, via the one or more processors that a chimney overheat condition exits based upon the determined temperature. The method may include additional, fewer, or alternate actions, including those discussed elsewhere herein.

In yet another aspect, a computer device for chimney safety may be provided. The computer device may include one or more local or remote processors, sensors, transceivers, servers, memory units, and/or other electronic or electrical components. For example, in one instance, the chimney safety device may include at least one temperature sensor configured to measure temperature associated with a portion of a chimney. The chimney safety device may further include one or more processors; and/or one or more memories coupled to the one or more processors. The one or more memories including computer executable instructions stored therein that, when executed by the one or more processors, may cause the one or more processors to: (1) determine a temperature based upon a temperature signal received from the at least one temperature sensor; and/or (2) determine that a chimney overheat condition exists based upon the determined temperature. The computer device may include additional, less, or alternate functionality, including that discussed elsewhere herein.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 illustrates an exemplary chimney safety system, according to an embodiment.

FIG. 2 illustrates an exemplary chimney.

FIG. 3 illustrates an exemplary thermocouple attached to an exemplary chimney via exemplary heat resistant tape.

FIG. 4 illustrates an exemplary table of historical data that may be used to train an overheat condition determining AI or ML algorithm.

FIG. 5 illustrates an exemplary chimney safety method or implementation, according to an embodiment.

### DETAILED DESCRIPTION

The present embodiments relate to, inter alia, improving chimney safety. For example, chimneys may become damaged when overheated. To reduce this risk, the systems and methods discussed herein may determine an overheat condition in a chimney and, in response, alert a homeowner and/or take other appropriate action. In addition, small animals may enter a chimney, and the techniques described herein may take appropriate action for this problem as well (e.g., alert the home owner, activate a device to repel the animal, prevent a fire from starting while the animal is in the chimney, etc.). In addition, an overheated fire may lead to embers escaping from the chimney, which in turn may lead to a fire on the roof of a house or at an animal nest on or near the roof of the house. The techniques described herein address this problem as well.

### Exemplary Chimney Safety System

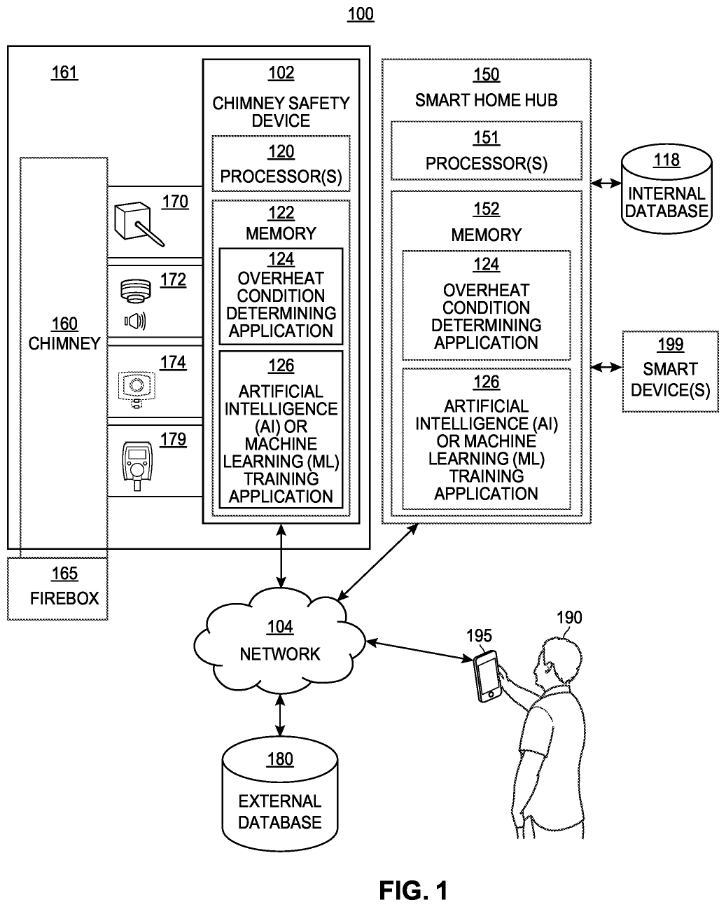

To this end, FIG. 1 illustrates an exemplary computer system 100 for chimney safety in which the exemplary computer-implemented methods described herein may be implemented. The high-level architecture includes both hardware and software applications, as well as various data communications channels for communicating data between the various hardware and software components.

For instance, a home may include a firebox 165 (e.g., a wood burning firebox, a gas burning firebox, etc.) at the base of a chimney 160. Part or all of the chimney 160 may be surrounded by chimney box 161, which separates the chimney 160 from surrounding building materials of a structure. A fire in the firebox 165 may cause the chimney 160 to overheat, which may be detected (e.g., as an overheat condition) by the exemplary system 100, such as via a chimney safety device 102 and/or a smart home hub 150.

The chimney safety device 102 may be placed in or proximate the chimney 160 to monitor conditions impacting chimney operation and safety. For example, the chimney safety device 102 may be disposed in otherwise unused space within a chimney box 161, with one or more sensors (discussed below) configured to measure aspects of the environment associated with the chimney 160. In further examples, one or more of the sensors supplying data to the chimney safety device 102 may be attached to or disposed within the chimney 160, such that the data is communicated via wired or wireless connections between the sensors and the chimney safety device 102. The chimney safety device 102 may include one or more processors 120 such as one or more microprocessors, controllers, and/or any other suitable type of processor. The chimney safety device 102 may further include a memory 122 (e.g., volatile memory, non-volatile memory) accessible by the one or more processors 120, (e.g., via a memory controller). The one or more processors 120 may interact with the memory 122 to obtain and execute, for example, computer-readable instructions stored in the memory 122. Additionally or alternatively, computer-readable instructions may be stored on one or more removable media (e.g., removable flash memory) that may be coupled to the chimney safety device 102 to provide access to the computer-readable instructions stored thereon. In particular, the computer-readable instructions stored on the memory 122 may include instructions for executing various applications, such as overheat condition determining application 124, and/or artificial intelligence (AI) or machine learning (ML) training application 126.

In operation, the overheat condition determining application 124 may determine an overheat condition in the chimney 160. For example, the overheat condition determining application 124 may determine the overheat condition based upon signals from any of a temperature sensor 170, a sound sensor 172, a camera 174, etc. It should be appreciated that even though the example of FIG. 1 illustrates only one of each of the temperature sensor 170, the sound sensor 172, and the camera 174, any number of temperature sensors, sound sensors 172, and/or cameras may be used. It should further be appreciated that the temperature sensor 170, the sound sensor 172, and/or the camera 174 may be housed within or separate from the chimney safety device 102. In some embodiments, the overheat condition determining application 124 may use an AI and/or ML algorithm to determine the overheat condition. As will be described elsewhere herein, the AI and/or ML algorithm may be trained by the AI and/or ML algorithm training application 126.

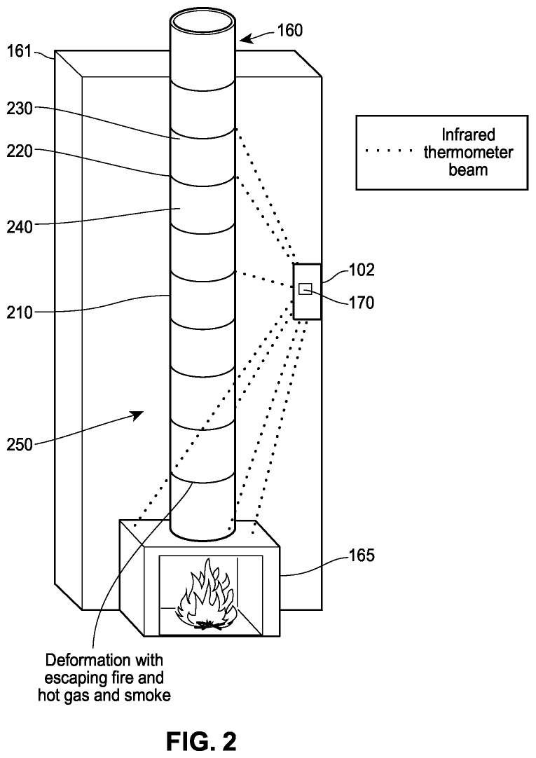

The temperature sensor(s) 170 may be any suitable temperature sensor(s) 170. Examples of the temperature sensor(s) 170 include: infrared (IR) temperature sensors, thermometers, thermistors, resistance temperature detectors (RTDs), thermopiles, thermocouples, etc. The temperature sensor(s) 170 may be configured to measure temperature at specific portions of the chimney 160. For instance, as illustrated in the example of FIG. 2, the chimney 160, which may include flue 210, may be constructed by joining different sections together, such as by joining a first section 230 with a second section 240. In the illustrated example, the first section 230 is joined with the second section 240 at connection section 220, which may include a connection material (e.g., mortar, metal connectors, high-temperature flue sealing tape, etc.) to join the first section 230 with the second section 240. Advantageously, the temperature sensor(s) 170 may be configured to measure the temperature specially at the joining sections 220. For example, when a fire overheats the chimney 160, the connection material may fail, thereby leading to the chimney 160 deforming (e.g., cracking, unscaling, or otherwise creating an unintended vent allowing hot gases to escape the flue 210). In addition, the connection material failure may be one of the first problems that occurs as the fire overheats. Thus, it is advantageous to measure the temperature specifically at connection section 220. Adding further to this advantage is that the overheat condition determining application 124 may take into account the specific temperatures at which the connection materials fail, and therefore take action at an appropriate time.

To this end, in the example of FIG. 2, the chimney safety device 102 includes a temperature sensor 170 comprising an IR temperature sensor configured to measure temperatures at connection sections, such as connection section 220. As illustrated in the example of FIG. 2, the chimney 160 may be surrounded by a chimney box 161, thereby forming a cavity 250 in which any of the chimney safety device 102, temperature sensor 170, sound sensor 172, camera 174, and/or animal repellant device 179 may be disposed. Furthermore, dangerously, animals or water may enter the cavity 250, and/or gases may escape from the chimney 160 into the cavity 250. Because the cavity 250 is generally not readily accessible, such and similar problems may persist for an extended duration without being observed, thereby increasing the likelihood of significant damage (e.g., by uncontrolled fire, water intrusion, or animal intrusion).

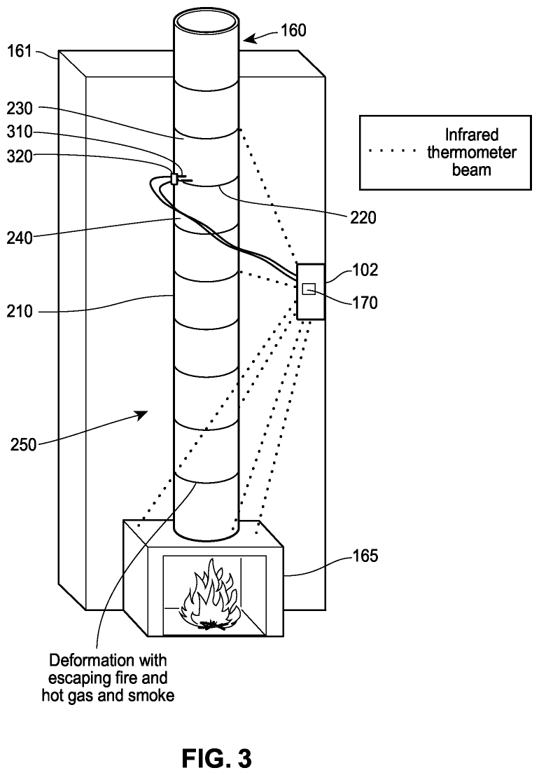

In some embodiments, such as in the example of FIG. 3, the temperature sensor is a thermocouple 310 that may be attached to the connection section 220 via heat resistant tape 320 (e.g., tape designed to withstand temperatures up to 1000° F. 1200° F., 1400° F. 1600° F. 1800° F. 2000° F., 2200° F., etc.).

The sound sensor 172 may be any suitable sound sensor, such as a microphone, etc. Signals from the sound sensor may be used as part of determining the overheat condition. Additionally or alternatively, signals from the sound sensor 172 may be used to detect an animal that has entered or is entering the chimney 160. The sound signals may further be used to detect water intrusion, such as by detecting sounds of dripping or running water.

The camera 174 may be any suitable camera capable of capturing imagery information (e.g., images, video, etc.). In some examples, the camera 174 may be used to determine the presence of fire, smoke, and/or animals. Such camera 174 may capture images in the visible spectrum or images outside the visible spectrum. Due to low light conditions and the usefulness of identifying thermal signatures, imaging in the IR spectrum may be particularly useful in detecting anomalous conditions for the chimney 160, such as damage to the flue 210, water intrusion, or presence of animals within the chimney box 161.

In some embodiments, the example system 100 also includes an animal repellant device 179. The animal repellant device 179 may be any device that may be configured to repel animals, such as by emitting ultrasonic waves, emitting a loud noise, etc. The animal repellant device may be controlled by the chimney safety device 102, and/or the smart home hub 150.

The exemplary system 100 may also include the smart home hub 150. In some embodiments, the smart home hub 150 may communicate with and/or control the chimney safety device 102. In some embodiments, there is no chimney safety device 102 and the smart home hub 150 directly communicates with other devices in the exemplary system 100, such as the temperature sensor 170, the sound senor 172, the camera 174, the animal repellant device 179, etc. The smart home hub 150 may also be connected to smart home devices 199, which may be any suitable smart home devices. Examples of the smart home devices include: smart washers, smart dryers, smart refrigerators, smart dishwashers, smart microwaves, smart cameras, smart doorbells, smart thermostats, smart sump pumps, smart light bulbs, smart speakers, smart toothbrushes, etc.

The smart home hub 150 may include one or more processors 151 such as one or more microprocessors, controllers, and/or any other suitable type of processor. Smart home hub 150 may further include a memory 152 (e.g., volatile memory, non-volatile memory) accessible by the one or more processors 151. (e.g., via a memory controller). The one or more processors 151 may interact with the memory 152 to obtain and execute, for example, computer-readable instructions stored in the memory 152. Additionally or alternatively, computer-readable instructions may be stored on one or more removable media (e.g., removable flash memory) that may be coupled to the smart home hub 150 to provide access to the computer-readable instructions stored thereon. In particular, the computer-readable instructions stored on the memory 152 may include instructions for executing various applications, such as overheat condition determining application 124, and/or artificial intelligence (AI) or machine learning (ML) training application 126.

The smart home hub 150 may also include or be in communication with an internal database 118. The internal database 118 may store any suitable information. For example, the internal database 118 may store data collected by the smart home hub 150 (e.g., from the chimney safety device 102, the temperature sensor 170, the sound sensor 172, the camera 174, the animal repellant device 179, the smart devices 199, etc.). In some embodiments, data held by the internal database 118 may be used to train any of the AI and/or ML algorithms discussed herein.

The exemplary system 100 may also include an external database 180, which may hold any suitable information. For example, the external database 180 may hold historical data used to train any of the AI and/or ML algorithms discussed herein. Further regarding the exemplary system 100, the illustrated exemplary components may be configured to communicate, e.g., via a network 104, with any other component. The network 104 may comprise components configured to facilitate communication via wired or wireless connections, which may include local or remote components.

Any of the components of the exemplary system 100 may be controlled by a user 190 of a mobile device 195 (e.g., comprising one or more processors, etc.). The mobile device 195 may be directly or indirectly (e.g., via network 104) connected to the smart home hub 150 to receive information from or control operation of the smart home hub 150. In some embodiments, the smart home hub 150 may be a virtual smart home hub running in a cloud or remote server, in which case the virtual smart home hub may receive sensor data from the chimney safety device 102 or sensors 170, 172, 174, 197 via the network 104. The mobile device 195 may serve as the user interface for such virtual smart home hub in such configurations.

Furthermore, although the example system 100 illustrates only one of each of the components, any number of the example components are contemplated (e.g., any number of chimneys, fireboxes, temperature sensors, sounds sensors, cameras, animal repellant devices, chimney safety devices, smart home hubs, smart devices, users, mobile devices, external databases, etc.).

Exemplary AI and/or ML Training

In some embodiments, AI and/or ML algorithms may be used to determine an overheat condition (e.g., via an overheat condition determining AI and/or ML algorithm), determine the presence of an animal (e.g., via an animal presence determining AI and/or ML algorithm), and/or determine water intrusion (e.g., via a water detecting AI and/or ML algorithm). It should be appreciated that although the following discussion may refer singularly to AI or ML algorithms, it applies equally to AI and ML algorithms. It should further be appreciated that although the following discussion refers to the AI and/or ML training application 126 (and/or the one or more processors 120) as training the AI and/or ML algorithms, the one or more processors 151, may train any of the AI and/or ML algorithms discussed herein.

In some embodiments, the AI and/or ML training application 126 may train the overheat condition determining ML algorithm to determine an overheat condition in the chimney 160. For example, the AI and/or ML training application 126 may receive the historical information to train the overheat condition determining machine learning algorithm, the animal presence determining machine learning algorithm, and/or the water detecting machine learning algorithm. In some examples, the historical information comprises: (a) inputs to the machine learning model (e.g., also referred to as independent variables, or explanatory variables), and/or (b) outputs of the machine learning model (e.g., also referred to as dependent variables, or response variables). The historical information may be received from any suitable source, such as the external database 180, the internal database 118, the chimney safety device 102, the temperature sensor 170, the sound sensor 172, the camera 174, the animal repellant device 179, etc.

In some such examples of the overheat condition determining ML algorithm, the dependent variables is the overheat condition that the overheat conditions determining ML algorithm is trained to determine (e.g., the dependent variable of the overheat condition determining ML algorithm is whether the overheat condition exists), and the independent variables are used to determine the dependent variables (e.g., an independent variable of the overheat condition determining ML algorithm may be a temperature of the chimney 160, etc.). Put another way, the independent variables may have an impact on the dependent variables, and the ML algorithms may be trained to find this impact.

More specifically, for the historical information used to train the overheat condition determining machine learning algorithm, examples of the independent variables may include: (i) historical temperatures; (ii) historical locations within historical chimneys of the historical temperatures; (iii) historical chimney dimensional data; (iv) historical connection materials; (v) historical construction materials; (vi) historical sound patterns; and/or (vii) historical imagery data (e.g., historical IR image patterns, historical flame colors, and/or historical lengths of flames). An example of the dependent variable in the historical information is the overheat condition.

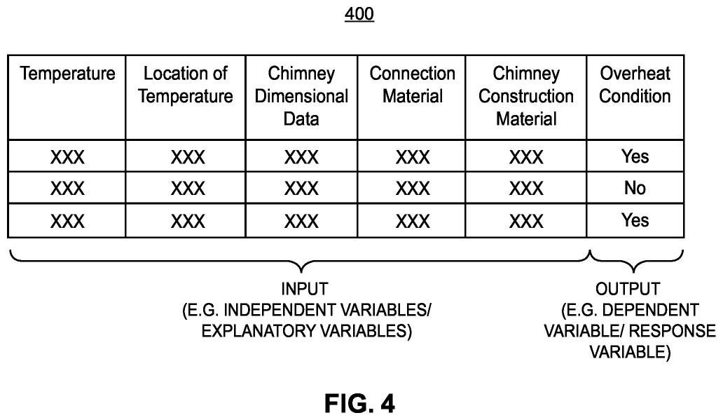

In some embodiments, the historical information may be held in the form of a table, such as the example table 400 illustrated in the example of FIG. 4. In this regard, it should be understood that the table 400 is an example table, and tables with more or fewer rows (e.g., more or less information) and/or columns (e.g., more or fewer independent variables and/or more or fewer dependent variables) are possible.

The historical temperature data may be any suitable historical temperature data. For example, the historical temperature data may be of a single point in a chimney or of multiple points in the chimney. The temperature may be in the form of degrees fahrenheit, degrees Celsius, degrees Kelvin, or in any other suitable form.

The historical location of temperature data may be in any suitable form. In some examples, the location may indicate distances above the firebox where the temperatures are taken. In other examples, the historical location data is indicated via a 1-dimensional (1D), 2-dimnesional (2D), and/or 3-dimensional (3D) coordinate system. Such data may be useful in determining whether hot gas is venting along the chimney flue, thus reducing heat a higher locations relative to lower locations.

The historical chimney dimensional data may indicate historical dimensions of the historical chimneys of the historical temperature and/or historical location of temperature data. In some examples, the historical chimney dimensional data may be indicated in the form of 1D, 2D, and/or 3D coordinate systems.

The historical connection materials may include information of connection materials (e.g., used to connect sections of the chimney, such as at connection section 220). Example historical connection materials include: types of mortars, types of metals, dimensions of the connection materials (e.g., thickness of a mortar in the connection section 220 or dimensions of a metal fastener), etc.

The historical chimney construction materials may include information relating to materials and designs used in the construction of historical chimneys (e.g., that of sections 230 and/or 240). Examples of the historical chimney construction materials include: types of metals, types of bricks, dimensions of the historical construction materials, etc.

Any of the historical information may be of chimneys generally (e.g., not just the chimney 160) and/or of the chimney 160 specifically (e.g., the specific chimney 160 for which the overheat condition determining training application 124 will be run). Advantageously, training on data of the chimney 160 specifically allows for a more accurate determination of overheat conditions (e.g., because the ML algorithm “learns” the specific characteristics of chimney 160). To this end, in some embodiments, a fire in the firebox 165 may be run a predetermined number of times (e.g., 2 times, 5, times, 10 times, 100 times, etc.) to gather the historical data. In some such embodiments, the user 190 indicates via the mobile device 195 if there was an overheat condition when the fire was run (e.g., as the dependent variable of the historical data). It should be appreciated that in some such embodiments, the historical data thus comes from the temperature sensor 170, sound sensor 172, and/or camera 174, one or more processors 120, one or more processors 151, etc. In some such embodiments, the one or more processors 120, and/or the one or more processors 151 perform the training.

In some embodiments, AI and/or ML training application 126 may train the animal presence determining ML algorithm to determine if an animal is present within or near the chimney 160 (e.g., with near the chimney being, for example, within 1 ft., 2 ft. 3 ft, 5 ft, 10 ft., etc. from the chimney). For example, the AI and/or ML training application 126 may receive the historical information to train the animal presence determining machine learning algorithm. In some examples, the historical information comprises: (a) inputs to the machine learning model (e.g., also referred to as independent variables or explanatory variables), and/or (b) outputs of the machine learning model (e.g., also referred to as dependent variables or response variables). The historical information may be received from any suitable source, such as the external database 180, the internal database 118, the chimney safety device 102, the temperature sensor 170, the sound sensor 172, the camera 174, the animal repellant device 179, etc.

In some such examples, the dependent variable is the presence of an animal that the animal presence determining ML algorithm is trained to determine (e.g., the dependent variable of the animal presence determining ML algorithm is the presence of an animal), and the independent variables are used to determine the dependent variables (e.g., an independent variable of the animal presence determining ML algorithm may be a sound pattern). Put another way, the independent variables may have an impact on the dependent variables, and the ML algorithms may be trained to find this impact.

More specifically, for the historical information used to train the animal presence determining machine learning algorithm, examples of the independent variables may include: (i) historical sound patterns; (ii) historical chimney dimensional data; (iii) historical open/shut information of chimneys (e.g., whether the chimney was open or shut when the historical sound pattern was taken) and/or (iv) historical images of animals in chimneys. An example of the dependent variable in the historical information is the presence of an animal.

The historical sound patterns include any sound patterns. Examples of the historical sound patterns include sound recordings of: animals entering chimneys, animals approaching chimneys, animals building nests in chimneys, fires, etc. It is advantageous to train the animal presence determining ML algorithm on sound recording of both animals in chimneys and fires from fireboxes because this helps the animal presence determining ML algorithm distinguish between fires and animals, thereby leading to a more accurate animal presence determining ML algorithm.

The historical chimney dimensional data may include any suitable data. The historical chimney dimensional data may be in the form of 1D, 2D, 3D data. Advantageously, including both the historical sound patterns and the historical chimney dimensional data in the training data improves accuracy of the animal presence determining ML algorithm because it allows the ML algorithm to “learn” how a chimney's dimensions affect the sound pattern.

Further advantageously, including both the historical sound patterns and the historical open/shut information of chimneys improves accuracy of the animal presence determining ML algorithm because the sound patterns are different depending on if the chimney is open or shut (e.g., at the top of the chimney, etc.).

In some embodiments, the historical data used to train the animal presence determining ML algorithm may be indicated in the form of a table (e.g., analogous to the example of FIG. 4 for the historical data used to train the overheat condition determining ML algorithm).

In some embodiments, AI and/or ML training application 126 may train the water detecting ML algorithm to determine if water intrusion is present in the chimney 160. For example, the AI and/or ML training application 126 may receive the historical information to train the water detecting machine learning algorithm. In some examples, the historical information comprises: (a) inputs to the machine learning model (e.g., also referred to as independent variables or explanatory variables), and/or (b) outputs of the machine learning model (e.g., also referred to as dependent variables or response variables). The historical information may be received from any suitable source, such as the external database 180, the internal database 118, the chimney safety device 102, the temperature sensor 170, the sound sensor 172, the camera 174, etc.

In some such examples, the dependent variable is the presence of water intrusion (e.g., leaking or dripping water) that the water detecting ML algorithm is trained to determine (e.g., the dependent variable of the water detecting ML algorithm is the presence of water within or around the chimney), and the independent variables are used to determine the dependent variables (e.g., an independent variable of the water detecting ML algorithm may be a sound pattern). Put another way, the independent variables may have an impact on the dependent variables, and the ML algorithms may be trained to find this impact.

More specifically, for the historical information used to train the water detecting machine learning algorithm, examples of the independent variables may include: (i) historical sound patterns; (ii) historical chimney dimensional data; (iii) historical open/shut information of chimneys (e.g., whether the chimney was open or shut when the historical sound pattern was taken) and/or (iv) historical images of water intrusion in chimneys. An example of the dependent variable in the historical information is the presence of water intrusion or water damage in or around a chimney.

The historical sound patterns include any sound patterns. Examples of the historical sound patterns include sound recordings of dripping or running water. It is advantageous to train the water detecting ML algorithm on sound recording of both water intrusion in chimneys and fires from fireboxes because this helps the water detecting ML algorithm distinguish between fires and water intrusion, thereby leading to a more accurate water detecting ML algorithm.

### Exemplary Chimney Safety Methods

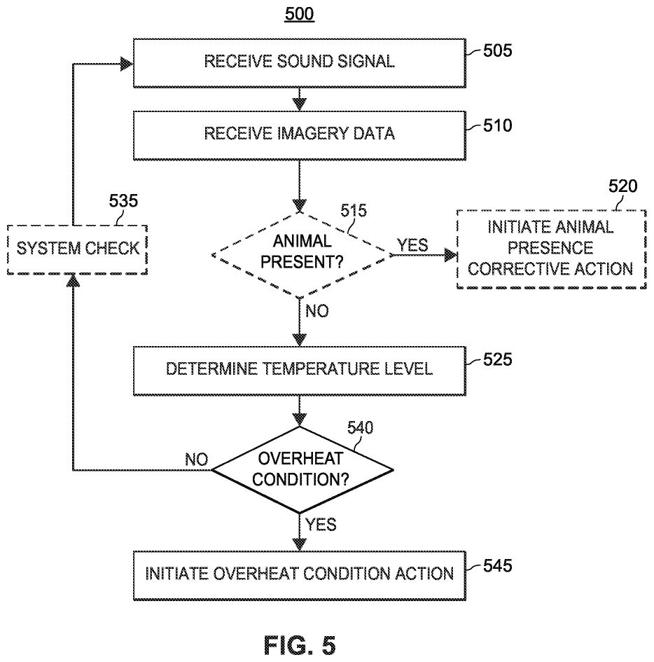

FIG. 5 shows an exemplary computer-implemented method or implementation 500 for chimney safety. Although the following discussion refers to the exemplary method or implementation 500 as being performed by the one or more processors 120, it should be understood that any or all of the blocks may be alternatively or additionally performed by any other suitable component as well (e.g., the one or more processors 151, etc.).

The exemplary method or implementation 500 may begin at block 505 when the one or more processors 120 receive a sound signal (or sound data) from the sound sensor 172. In some embodiments, the one or more processors 120 also receive an indication (e.g., from the mobile device 195, etc.) indicating if the chimney 160 is open or closed. Advantageously, this may help the one or more processors 120 analyze the sound signal because the sound pattern will be different in the chimney 160 depending on if the chimney is open or closed. In some embodiments, sound signal data may only be received when a measured sound exceeds a threshold (e.g., when a sound above a low background level is detected to be present).

At block 510, the one or more processors 120 may receive imagery data (e.g., image data, video data, etc.) from the camera 174. The imagery data may be obtained for one or more locations associated with the chimney 160 at one or more times (e.g., instantaneous or time-series data). In some embodiments, the imagery data may comprise raw or compressed images in one or more imaging modes captured by the camera 174. In further embodiments, the imagery data may comprise pre-processed data derived from one or more images captured by the camera 174, such as average or variance metrics for image pixels, regions or metrics of change from previous images, etc.

At optional block 515, the one or more processors 120 may determine if an animal is present within or near the chimney 160 using the obtained sensor data. The animal may be any kind of animal, such as a rodent, a bird, etc. In some embodiments, detecting the presence of an animal may include detecting the presence of a nest or other material associated with an animal, which may further increase the risk of uncontrolled fire. The animal presence may be determined by any suitable technique. For example, the animal presence determining ML algorithm (e.g., trained as described above, etc.) may be used. In some such examples, the sound signal and/or sound data (e.g., received at block 505), the imagery data (e.g., received at block 510). and/or dimensional data of the chimney 160 may be input into the animal presence determining ML algorithm to determine if an animal is present. Further optionally, if the presence of an animal is identified, the one or more processors 120 may further identify a type of animal.

If an animal is determined to be present, the one or more processors 120 may initiate an animal presence corrective action (block 520). In one example, the animal presence corrective action includes activating the animal repellant device 179 (e.g., to cause the animal to leave the chimney 160 or area near the chimney). In some embodiments, the corrective action taken depends on the type of animal identified. For example, a frequency may be emitted by the animal repellant device 179 is a specific frequency (or range of frequencies) known to deter the specific type of detected animal.

Additionally or alternatively, the animal presence corrective action may include sending an alert to the mobile device 195, and/or smart device(s) 199 that an animal has been detected in or near the chimney 160. The alert may be visual, auditory, and/or haptic. Additionally or alternatively, the animal presence corrective action may include automatically shutting off gas to the firebox 165 (e.g., if the firebox is a gas burning firebox).

In some embodiments, the presence of an animal is checked (e.g., at optional block 515) periodically (e.g., every minute, every hour, every day, etc.). Additionally or alternatively, the presence of an animal may be checked when an animal check is initiated by the mobile device 195 or other smart device 199 (e.g., user 190 checks presence of an animal before starting a fire).

At block 525, the one or more processors 120 determine a temperature level or levels. For example, the one or more processors 120 may receive temperature signal(s) from the temperature sensor(s) 170 and/or other sensors, which may be used to determine the temperature level(s).

The temperature levels may be determined at a single point in the chimney 160 or at more than one point. For instance, as illustrated in the example of FIG. 2, the temperature sensor 170 may measure the temperatures of connecting sections of the chimney 160 (e.g., 220), individual sections (e.g., 230, 240), the firebox 165, etc. If temperatures at more than one location are taken, individual or multiple temperature sensors may be used. For example, there may be a separate temperature sensor for each point measured. Additionally or alternatively, a rotation device (e.g., including a motor, etc.) may move the temperature sensor (e.g., an IR sensor, as in the example of FIG. 2) so that the temperature sensor measures the temperature at the points desired. It is advantageous to measure the temperate at the connecting sections because these sections are likely the first to fail.

In some embodiments, the one or more processors 120 also record or receive timestamp data along with the temperature data. In some embodiments, the one or more processors 120 also receive or determine locations of the temperatures within the chimney 160.

At any point in time, the temperatures (possibly along with indications of the temperature locations within the chimney 160 and/or times the temperatures were taken) may be displayed at the mobile device 195 and/or smart devices 199.

At block 530, the one or more processors 120 determine if there is an overheat condition. The overheat condition may be determined in any suitable way. For example, if any of the determined temperatures is above a temperature threshold (e.g., 1000° F., 1100° F., 1200° F., 1500° F. 1700° F. 1900° F., 2000° F. 2100° F., 2200° F., 2400° F., 2600° F., etc.) an overheat condition may be determined. In some embodiments, the overheat condition is determined if any of the temperatures are over the temperature threshold for a predetermined time period (e.g., 1 second, 5 seconds, 10 seconds, 30 seconds, 1 minute, 2 minutes, etc.). In some examples, the temperature threshold and/or the predetermined time period are based upon a connection material of the chimney 160. For instance, a user may enter a connection material (e.g., a type of mortar, a type of metal fastener, etc.) into her mobile device 195, and the one or more processors 120 may determine the temperature threshold and/or the predetermined time period based upon the entered information (e.g., via a lookup table, etc.).

In some embodiments, the overheat condition determination may be made based upon a temperature pattern (e.g., in space and/or time). For instance, the overheat condition may be determined when a first temperature at a first distance from the firebox 165 is above a first temperature threshold for a first predetermined period of time; and/or when a second temperature at a second distance from the firebox 165 is above a second temperature threshold for a second predetermined period of time.

In some embodiments, the overheat condition determination made based wholly or partially on the sound signal (e.g., received at block 505). For example, the temperature threshold(s) and/or predetermined time period(s) may be wholly or partially based upon the sound signal. For instance, the sound signal may indicate a particular kind of material being burned, which may indicate that the fire will heat up more or less quickly. In another example, the sound signal indicates that fire is leaking through sections of the chimney 160 (e.g., through section 220, etc.); and, in response to the determination of fire leaking through the section, an overheat condition is automatically determined.

In some embodiments, the overheat condition determination made based wholly or partially on the imagery data (e.g., received at block 510). For example, the temperature threshold(s) and/or predetermined time period(s) may be wholly or partially based upon the imagery data. For instance, the imagery data may indicate a color of the fire, which may in turn be used to increase or decrease any of the temperature threshold(s) and/or predetermined time period(s). In another example, the imagery data may indicate a distance that the flames are reaching into the chimney 160, which may in turn be used to increase or decrease any of the temperature threshold(s) and/or predetermined time period(s).

In some embodiments, the overheat condition determination is made via the overheat condition determination AI and/or ML algorithm (e.g., trained as described elsewhere herein). For example, any of the temperatures (e.g., determined at block 525) (e.g., optionally along with location data indicating the temperature locations within the chimney 160), sound signals (e.g., received at block 505), imagery data (e.g., receive at block 510), dimensional data of the chimney 160, connection material data of the chimney 160, and/or construction material data of the chimney 160 may be input into the overheat condition determination AI and/or ML algorithm to determine if an overheat condition exists.

If an overheat condition does not exist, the one or more processors 120 may optionally do a system check at block 535. For example, if the sound signal or the imagery data indicates that there is a fire in the firebox 165, but the temperature level(s) do not indicate that there is a fire (e.g., based upon a system check temperature threshold), the one or more processors 120 may determine that there is a system error. If there is a system error, the one or more processors 120 may send an alert (e.g., to the mobile device 195 and/or smart device(s)) indicating that there is a system error (e.g., and optionally indicating information of the error, such as that the imagery data and/or sound signal indicates that there is a fire, but the temperature level indicates that there is not a fire).

Additionally or alternatively, at block 535, the one or more processors 120 may check the sound signal to determine if the sound pattern is normal. This check is advantageous because deformation of the chimney sections will cause the sound pattern to change. To implement this check, in some examples, the one or more processors 120 may train a normal operation determining AI and/or ML algorithm from historical sound signals of the chimney 160, and thus, over time, the AI and/or ML algorithm “learns” the normal sound patterns of the chimney 160. Using this trained normal operation determining AI and/or ML algorithm, the one or more processors 120 may determine if the chimney is operating normally. If it is determined that the system is not operating normally, a general warning (e.g., possibly indicating that the chimney should be inspected) may be sent to the mobile phone 195 and/or smart device(s) 199. For example, a trained water detecting machine learning algorithm may be used to determine whether a leak or water intrusion may be present and should be inspected based upon the sensor data (e.g., by identifying sound patterns over a time interval).

If the overheat condition is determined, an overheat condition action may be initiated at block 545. The overheat condition action may be any suitable action to remediate the overheat condition. For example, the overheat condition action may be to shut off gas to the firebox 165 (if the fire box is a gas, not wood burning, firebox). In another example, the overheat condition action may be to send an alert to the mobile device 195, and/or smart devices 199 indicating the overheat condition. The alert may also display the determined temperature levels, times of the temperature levels, etc. In another example, the overheat condition action may be to alert emergency responders, such as firefighters of the overheat condition. It should be appreciated that more than one of these example overheat condition actions may be initiated at block 545 in response to the determination of the overheat condition.

In addition, at any point in the exemplary method or implementation 500, the sound signal and/or imagery data may be checked for indications of leaking water. If water is determined to be leaking into the chimney 160, an alert indicating the leaking water may be sent to the mobile device 195 and/or smart device(s) 199. This advantageously further improves chimney safety because leaking water may cause damage to the chimney 160, which in turn makes it easier for fires to even further damage the chimney 160.

It should be understood that not all blocks and/or events of the exemplary flowchart are required to be performed. The exemplary signal diagrams and/or flowcharts may include additional, less, or alternate functionality, including that discussed elsewhere herein.

### Additional Exemplary Embodiments

In one aspect, a chimney safety system may be provided. The chimney safety system may include one or more local or remote processors, sensors, transceivers, servers, memory units, and/or other electronic or electrical components. For example, in one instance, the chimney safety system may include at least one temperature sensor configured to measure temperature associated with a portion of a chimney. The chimney safety system may further include one or more processors configured to: (1) determine a temperature based upon a temperature signal received from the at least one temperature sensor; and/or (2) determine that a chimney overheat condition exists based upon the determined temperature. The computer system may include additional, less, or alternate functionality, including that discussed elsewhere herein.

In some embodiments, the one or more processors are further configured to determine that the chimney overheat condition exists based upon the determined temperature being above a temperature threshold for a predetermined time period.

In some embodiments, the one or more processors are further configured to: receive an indication of a material comprised in the chimney; and/or determine both the temperature threshold and the predetermined time period based upon the material.

In some embodiments, the at least one temperature sensor comprises: an infrared temperature sensor, thermometer, a thermistor, resistance temperature detector (RTD), and/or a thermopile.

In some embodiments, the at least one temperature sensor comprises an infrared temperature sensor; and/or the system further comprises a rotation device configured to hold the infrared temperature sensor and rotate the infrared temperature sensor such that the infrared temperature sensor measures temperature at: (i) a first connection section of the chimney that connects first chimney section with a second chimney section, and/or (ii) a second connection section of the chimney that connects the second chimney section to a third chimney section.

In some embodiments, the at least one temperature sensor comprises a thermocouple; and/or the thermocouple is attached to the chimney via heat resistant tape.

In some embodiments, the thermocouple is attached to the chimney at a connection section of the chimney that connects a first chimney section with a second chimney section.

In some embodiments, the one or more processors are further configured to: receive historical temperature data of the chimney; train an overheat condition determining artificial intelligence (AI) algorithm by inputting the historical temperature data into the overheat condition determining AI algorithm; and/or determine the chimney overheat condition by inputting the determined temperature into the trained overheat condition determining AI algorithm.

In some embodiments, the system may further include an animal repellent device configured to emit ultrasonic waves into and/or in proximity to (e.g., within 1 ft., 2 ft. 3 ft, 5 ft, 10 ft., etc. of the chimney) the chimney to repel animals.

In some embodiments, the system may further include a chimney safety device disposed within a chimney box surrounding at least a portion of a flue of the chimney, and/or wherein: the one or more processors are disposed within the chimney safety device; the at least one temperature sensor is disposed within the chimney safety device; and/or the one or more processors are configured to: in response to determining the chimney overheat condition, send an alert to a mobile device of a user.

In some embodiments, the system may further include a smart home hub disposed outside of the chimney, and/or wherein: the one or more processors are disposed within the smart home hub; and/or the one or more processors are configured to: in response to determining the chimney overheat condition, send an alert to a mobile device of a user.

In some embodiments, the system may further include a sound monitoring device, and/or wherein the one or more processors are further configured to determine the chimney overheat condition based upon a signal generated by the sound monitoring device.

In some embodiments, the system may further include a sound monitoring device, and/or wherein the one or more processors are further configured to: determine that a fire is occurring based upon a sound signal generated by the sound monitoring device; in response to the determination that a fire is occurring, determine if the determined temperature is above a system check temperature threshold; and/or if the determined temperature is not above the system check temperature threshold, send an error message to a mobile device of a user or a smart home hub associated with the user.

In some embodiments, the one or more processors are further configured to: in response to determining the chimney overheat condition, send a signal to a fireplace gas controller to shut off gas to a fireplace.

In some embodiments, the system may further include a sound sensor, and/or wherein: the one or more processors are further configured to detect the presence of an animal in the chimney by inputting sound data generated via the sound sensor into an animal presence determining machine learning (ML) algorithm trained by inputting historical sound patterns; (ii) historical chimney dimensional data; (iii) historical open/shut information of chimneys; and/or (iv) historical images of animals in chimneys to train the animal presence determining ML algorithm.

In another aspect, a computer-implemented method for chimney safety may be provided. The method may be implemented via one or more local or remote processors, sensors, transceivers, servers, memory units, and/or other electronic or electrical components. For instance, in one example, the method may include: (1) receiving, via one or more processors, a temperature signal from a temperature sensor configured to measure a temperature associated with a portion of a chimney; (2) determining, via the one or more processors, a temperature level from the temperature sensor; and/or (3) determining, via the one or more processors that a chimney overheat condition exits based upon the determined temperature. The method may include additional, fewer, or alternate actions, including those discussed elsewhere herein.

In some embodiments, determining the chimney overheat condition comprises determining that the chimney overheat condition exists based upon the determined temperature being above a temperature threshold for a predetermined time period.

In yet another aspect, a computer device for chimney safety may be provided. The computer device may include one or more local or remote processors, sensors, transceivers, servers, memory units, and/or other electronic or electrical components. For example, in one instance, the chimney safety device may include at least one temperature sensor configured to measure temperature associated with a portion of a chimney. The chimney safety device may further include one or more processors; and/or one or more memories coupled to the one or more processors. The one or more memories including computer executable instructions stored therein that, when executed by the one or more processors, may cause the one or more processors to: (1) determine a temperature based upon a temperature signal received from the at least one temperature sensor; and/or (2) determine that a chimney overheat condition exists based upon the determined temperature. The computer device may include additional, less, or alternate functionality, including that discussed elsewhere herein.

In some embodiments, the one or more memories having stored thereon computer executable instructions that, when executed by the one or more processors, cause the computer device to: determine that the chimney overheat condition exists based upon the determined temperature being above a temperature threshold for a predetermined time period.

In some embodiments, the at least one temperature sensor comprises: an infrared temperature sensor, thermometer, a thermistor, resistance temperature detector (RTD), and/or a thermopile.

### Other Matters

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating.” “determining,” “presenting,” “displaying.” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising.” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention. Furthermore, the patent claims at the end of this patent application are not intended to be construed under 35 U.S.C. § 112 (f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A chimney safety system, the chimney safety system comprising:
at least one temperature sensor configured to measure temperature associated with a portion of a chimney; and
one or more processors configured to:
determine a temperature based upon a temperature signal received from the at least one temperature sensor; and
determine that a chimney overheat condition exists based upon the determined temperature.

2. The system of claim 1, wherein the one or more processors are further configured to determine that the chimney overheat condition exists based upon the determined temperature being above a temperature threshold for a predetermined time period.

3. The system of claim 2, wherein the one or more processors are further configured to:
receive an indication of a material comprised in the chimney; and
determine both the temperature threshold and the predetermined time period based upon the material.

4. The system of claim 1, wherein the at least one temperature sensor comprises: an infrared temperature sensor, thermometer, a thermistor, resistance temperature detector (RTD), or a thermopile.

5. The system of claim 1, wherein:
the at least one temperature sensor comprises an infrared temperature sensor; and
the system further comprises a rotation device configured to hold the infrared temperature sensor and rotate the infrared temperature sensor such that the infrared temperature sensor measures temperature at: (i) a first connection section of the chimney that connects first chimney section with a second chimney section, and (ii) a second connection section of the chimney that connects the second chimney section to a third chimney section.

6. The system of claim 1, wherein:
the at least one temperature sensor comprises a thermocouple; and
the thermocouple is attached to the chimney via heat resistant tape.

7. The system of claim 6, wherein the thermocouple is attached to the chimney at a connection section of the chimney that connects a first chimney section with a second chimney section.

8. The system of claim 1, wherein the one or more processors are further configured to:
receive historical temperature data of the chimney;
train an overheat condition determining artificial intelligence (AI) algorithm by inputting the historical temperature data into the overheat condition determining AI algorithm; and
determine the chimney overheat condition by inputting the determined temperature into the trained overheat condition determining AI algorithm.

9. The system of claim 1, further comprising an animal repellent device configured to emit ultrasonic waves into and/or in proximity to the chimney to repel animals.

10. The system of claim 1, further comprising a chimney safety device disposed within a chimney box surrounding at least a portion of a flue of the chimney, and wherein:
the one or more processors are disposed within the chimney safety device;
the at least one temperature sensor is disposed within the chimney safety device; and
the one or more processors are configured to: in response to determining the chimney overheat condition, send an alert to a mobile device of a user.

11. The system of claim 1, further comprising a smart home hub disposed outside of the chimney, and wherein:
the one or more processors are disposed within the smart home hub; and
the one or more processors are configured to: in response to determining the chimney overheat condition, send an alert to a mobile device of a user.

12. The system of claim 1, further comprising a sound monitoring device, and wherein the one or more processors are further configured to determine the chimney overheat condition based upon a signal generated by the sound monitoring device.

13. The system of claim 1, further comprising a sound monitoring device, and wherein the one or more processors are further configured to:
determine that a fire is occurring based upon a sound signal generated by the sound monitoring device;
in response to the determination that a fire is occurring, determine if the determined temperature is above a system check temperature threshold; and
if the determined temperature is not above the system check temperature threshold, send an error message to a mobile device of a user or a smart home hub associated with the user.

14. The system of claim 1, wherein the one or more processors are further configured to:
in response to determining the chimney overheat condition, send a signal to a fireplace gas controller to shut off gas to a fireplace.

15. The system of claim 1, further comprising a sound sensor, and wherein:
the one or more processors are further configured to detect the presence of an animal in the chimney by inputting sound data generated via the sound sensor into an animal presence determining machine learning (ML) algorithm trained by inputting historical sound patterns; (ii) historical chimney dimensional data; (iii) historical open/shut information of chimneys; or (iv) historical images of animals in chimneys to train the animal presence determining ML algorithm.

16. A computer-implemented method for chimney safety, the method comprising:
receiving, via one or more processors, a temperature signal from a temperature sensor configured to measure a temperature associated with a portion of a chimney;
determining, via the one or more processors, a temperature level from the temperature signal; and
determining, via the one or more processors that a chimney overheat condition exits based upon the determined temperature.

17. The computer-implemented method of claim 16, wherein determining the chimney overheat condition comprises determining that the chimney overheat condition exists based upon the determined temperature being above a temperature threshold for a predetermined time period.

18. A computer device for chimney safety, the computer device comprising:
at least one temperature sensor configured to measure temperature associated with a portion of a chimney;
one or more processors; and
one or more memories, the one or more memories having stored thereon computer-executable instructions that, when executed by the one or more processors, cause the computer device to:
determine a temperature based upon a temperature signal received from the at least one temperature sensor; and
determine that a chimney overheat condition exists based upon the determined temperature.

19. The computer device of claim 18, the one or more memories having stored thereon computer executable instructions that, when executed by the one or more processors, cause the computer device to:
determine that the chimney overheat condition exists based upon the determined temperature being above a temperature threshold for a predetermined time period.

20. The computer device of claim 18, wherein the at least one temperature sensor comprises: an infrared temperature sensor, thermometer, a thermistor, resistance temperature detector (RTD), or a thermopile.
